(19) United States
(12) Patent Application Publication
(10) Pub. No.: US 2007/0233822 A1
(43) Pub. Date: Oct. 4, 2007

(54) Decrease recovery time of remote TCP client applications after a server failure

(75) Inventors: James V. Farmer, Wappingers Falls, NY (US); Mark R. Gambino, Brewster, NY (US)

Correspondence Address: Eugene I. Shkurko;IBM Corporation - MS P386, 2455 South Road, Poughkeepsie, NY, 12601, US

(73) Assignee: International Business Machines Corporation, Armonk, NY (US)

(21) Appl. No.: 11/396,778

(22) Filed: Apr. 3, 2006

(51) Int. Cl. G06F 15/177; G06F 15/173

(52) U.S. Cl. 709/220; 709/223

(57) ABSTRACT

An apparatus and method for saving client/server socket state information to recoverable storage (disk, nonvolatile cache, tape, or other storage). After a server failure, upon recovery the server will be able to send out RSTs to inform remote clients of the server failure. The result is faster recovery for the remote clients that will be able to clean up and restart sockets/transactions as soon as the server side becomes active rather than waiting for a long timeout condition or for programmed or human intervention on the client/network side.

### BACKGROUND OF THE INVENTION

1. Technical Field of the Invention

This invention pertains to network communications. In particular, this invention reduces the time and effort needed to recover applications after a server or client failure occurs.

Typically, client nodes communicate with a server node over a network using TCP sockets. The network can be a private network, such as an intranet, or the Internet. The client nodes start a TCP socket by sending a connection request (SYN message) to the server. The normal response by the server is a SYN/ACK message to accept the connection request. When a socket ends normally (is closed by an application), each node sends an “end connection” message (FIN) to the other node. If a server side application program fails without first closing its sockets, the system cleans up the sockets and informs the remote node (e.g. client) of the failure by sending a reset message (RST).

The TCP architecture, first defined by Request for Comments (RFC) 793 and revised by subsequent RFCs over time, states that it is not required that notification be sent when a socket fails and that the remote node must be able to handle this situation. An example of this is where a TCP socket exists between client X and server Y, then client X is powered off without being able to shutdown gracefully. In this case, no FIN or RST is sent to server Y. When client X is powered on again and attempts to start a new socket with server Y (using the same IP addresses and port numbers as the old socket), server Y could still think the old socket is still active. If so, when client X sends the connection request (SYN message) to start a new socket, server Y has two options according to the (RFC) architecture:

1. Send an ACK message (not SYN/ACK) that includes the next expected sequence number that the server expects to receive from the client on the old socket. This can be considered rather like a rejection by the server. The client will then send a RST message to the server to clean up the old socket, then resend the SYN message to start a new socket.

2. Realize that the client failed and has come back up, in which case the server cleans up the old socket information within the server and accepts the connection request by sending a SYN/ACK.

Another example is where a TCP socket exists between client X and server Y. Server Y fails without notifying the client (no FIN or RST is sent), then server Y comes back up. The recovery in this situation depends on what actions the client takes and when:

1. If the client attempts to send data to the server before the server has come back up, the client will not receive an acknowledgment (ACK) indicating that the server has received the data. This will cause the client to assume the data was lost in the network and use standard TCP retransmit processing to resend the data to the server. This process repeats until the retransmit limit is reached, which then causes the client to clean up the socket on its end. The client may or may not send a RST in this case.

2. If the client does not try to send any data to the server in between the time that the server failed and came back up, the client still thinks the old socket exists. The next time that the client sends data to the server, the server will reject the data (with a RST message) because the socket no longer exists on the server. This will cause the client to clean up the socket on its end, then the client will start a new socket.

When a socket application issues a read API to wait for a message to arrive from the remote application, the local application is suspended until a message arrives, or until a user-defined timeout occurs. The SO_RCVTIMEO socket option controls how long to wait for a message to arrive before a timeout occurs. If the SO_RCVTIMEO value is 0, there is no timeout and so the defined waiting period is indefinite, requiring a manual or programmed intervention. On many systems, SO_RCVTIMEO is 0 (which is the default value).

2. Description of the Prior Art

### Exemplary problem 1

In this example there are multiple TCP clients connected to a server application. Some or all of these clients send a message to the server across its TCP socket connection, but the server fails before a response message could be sent. The sequence of events (absent the present invention) is illustrated in the flowchart of FIG. 1, as follows. Initially, a TCP socket exists between client X and server Y.

In step 101, a client application issues a socket send API and the request message is sent to the network. In step 102, the client application issues a socket read API, which causes the client application thread to be suspended, waiting for the reply message from the server. In this example, the timeout value on the read is 5 minutes (SO_RCVTIMEO for this socket is set to 5 minutes). In step 103, the request message arrives at the server node and the server TCP/IP stack acknowledges receipt of the message by sending TCP ACK to the client node. In step 104, the server application begins processing the request message. In step 105, before the reply message is built on the server, the server node experiences a hard error and is forced to reboot. Because the server did not come down in a normal procedure, the server was unable to notify the remote clients of the failure (the server was unable to send TCP RSTs to the remote client nodes). In step 106, the server node comes back up (reboot is completed) and the server application is restarted, waiting for remote clients to reconnect. In this example, we hypothetically assume that the server reboot process took one minute. In step 107, four minutes later, the read API times out on the client node, the client application is posted, and restarts the transaction (starts a new socket with the server).

In this first example, even though the server node was only down for one minute, the application outage was extended an extra four minutes. If the client node had no timeout value specified on its read API, then the application outage would have been extended even longer until a human operator or programmed intervention was taken on the client node.

### Exemplary problem 2

Sometimes there are nodes between the client and the server that try to keep track of socket state information, such as routers, stateful firewalls, etc. Some of these devices do not work well if sockets fail without notification (either a FIN or RST) flowing in the network. A router or firewall, or other network node, might think a socket between client X and server Y still exists (even though it does not) and prevent client X from starting a new socket with server Y because an RST was never issued to clean up the old socket. Manual intervention of the stateful firewall is required in this case. These stateful devices may reside outside of the server data center, which can further extend the outage time trying to locate the device that needs to be rebooted to clean up its state information. A sample sequence of events for this case is as follows (not shown in Figures):

1. Client X sends a TCP connection request to server Y. A stateful firewall in front of server Y sees that no socket exists between X and Y; therefore, the firewall passes the request to the server, the socket between X and Y is established, and the firewall is aware that the socket exists.

2. The server node experiences a hard error and is forced to reboot. Because the server did not come down in a normal procedure, the server was unable to notify the firewall or remote client of the failure (the server was unable to send TCP RSTs to the remote client nodes). Both the firewall and remote client still think the socket between client X and server Y exists.

3. The client sends a request message on the socket.

4. Because the server is down (still in the reboot process), no acknowledgment (ACK) to the client message is received causing the client to go through standard TCP retransmit processing. Eventually, the retransmit limit defined in the client node is reached and the client node cleans up the socket internally (no RST is sent).

5. The server node comes back up (reboot is completed) and the server application is restarted, waiting for remote clients to reconnect.

6. Client X sends a TCP connection request (SYN message) to try to restart its connection with server Y (using the same IP addresses and port numbers). The firewall (or router) thinks the old socket still exists and therefore rejects the connection request (sends a RST to the client to reject the SYN message) rather than passing the connection request to the server.

In this example, the network administrator must manually reset information in the stateful firewall before the client is able to reconnect to the server. This can extend the application outage by several minutes to over a hour depending on how long it takes to identify and correct the network device that has old state information.

What these examples show is that even though the TCP architecture does not require that notification (FIN or RST) be sent, in current practice there are numerous delays and problems that can occur if a node with many sockets (such as a server) fails without gracefully cleaning up its sockets.

It is an object of the invention to speed up network socket clean up and recovery time.

It is another object of the invention to store network information related to socket data prior to node failures.

### SUMMARY OF THE INVENTION

A method and apparatus of the present invention includes receiving network messages via a network input, by a server or other computing device, and storing socket information in nonvolatile storage for each message sufficient to identify and reestablish the socket after a restart due to server failure or other shutdown. Each message carries pertinent socket information for that message and the information is easily obtained from, for example, the message header. Because sockets can be reestablished by requesting clients after a server shutdown and restart, the server, or other computing device, needs to verify if a socket has been reestablished in such a manner before sending socket reset messages to the network based on the stored socket information.

Other embodiments that are contemplated by the present invention include computer readable media and program storage devices tangibly embodying or carrying a program of instructions readable by a machine or a processor, for having the machine or computer processor execute instructions or data structures stored thereon. Such computer readable media can be any available media which can be accessed by a general purpose or special purpose computer. Such computer-readable media can comprise physical computer-readable media such as RAM, ROM, EEPROM, CD-ROM or other optical disk storage, magnetic disk storage or other magnetic storage devices, for example. In the context of the present invention, the terms “storage” and “memory” are used synonymously, even though in a more precise sense they might refer to specialized types of storage and memory. Any other media which can be used to carry or store software programs which can be accessed by a general purpose or special purpose computer are considered within the scope of the present invention.

These, and other, aspects and objects of the present invention will be better appreciated and understood when considered in conjunction with the following description and the accompanying drawings. It should be understood, however, that the following description, while indicating preferred embodiments of the present invention and numerous specific details thereof, is given by way of illustration and not of limitation. Many changes and modifications may be made within the scope of the present invention without departing from the spirit thereof, and the invention includes all such modifications.

### BRIEF DESCRIPTION OF THE DRAWINGS

FIG. 1 is a flow chart of a client/server session where the server experiences a hard failure.

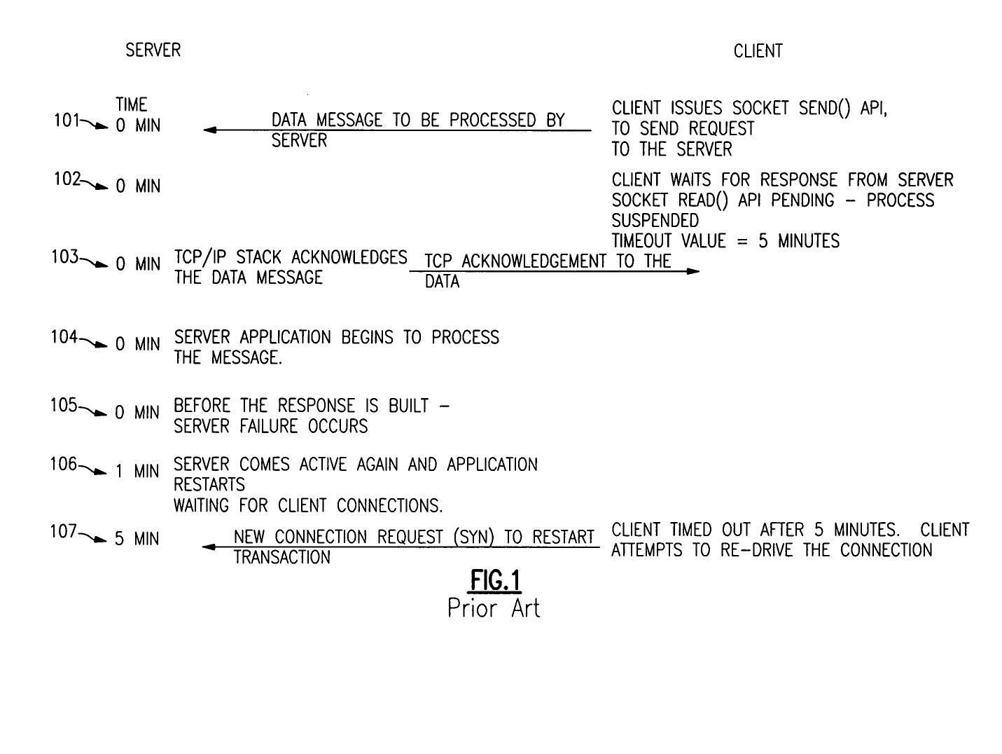

FIG. 2 is a flow chart of a client/server session implementing the present invention to handle the hard server failure of FIG. 1.

FIG. 3 illustrates an implementation of the present invention using external storage.

FIG. 4 illustrates an implementation of the present invention using internal memory.

FIG. 5 illustrates a verification procedure of the present invention.

### BEST MODE FOR CARRYING OUT THE INVENTION

By implementing the present invention, the server writes enough socket state information to recoverable storage (magnetic or optical disk, nonvolatile cache, or other storage) such that after the failure when the server comes back up, the server will be able to send out RSTs to inform remote clients of the server failure. The end result is faster recovery as the remote clients will be able to clean up and restart sockets/transactions as soon as the server side comes active again rather than having to wait for a long timeout condition or human intervention on the client/network side.

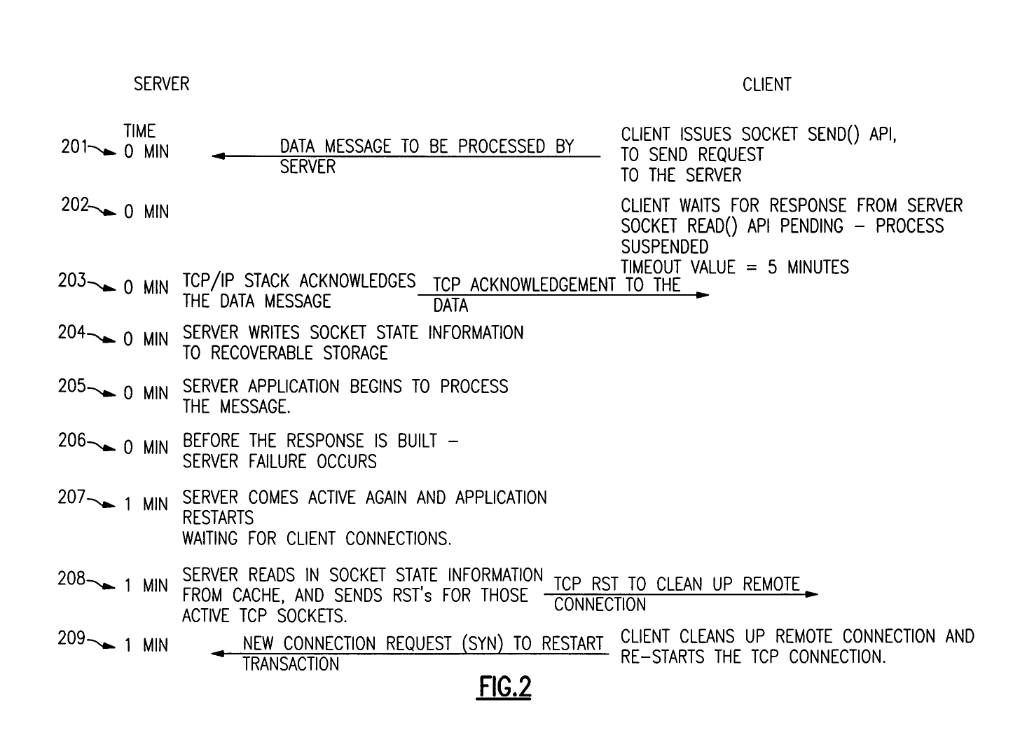

The sequence of events for problem 1, described above, derives benefits by use of the present invention as illustrated in the flowchart of FIG. 2. With reference to that figure, initially a TCP socket exists between client X and server Y. In step 201, a client application issues a socket send API and the request message is sent to the network. In step 202, the client application issues a socket read API, which causes the client application thread to be suspended, waiting for the reply message from the server. In this example, the timeout value on the read is 5 minutes (SO_RCVTIMEO for this socket is set to 5 minutes). In step 203, the request message arrives at the server node. The server TCP/IP stack acknowledges receipt of these message by sending TCP ACK to the client node. In step 204, the server node writes the updated socket state information (such as sequence numbers) to its cache in recoverage storage. In step 205, the server application begins processing the request message. In step 206, before the reply message is built, the server node experiences a hard error and is forced to reboot. Because the server did not perform a normal shutdown, the server was unable to notify the remote clients of the failure (the server was unable to send TCP RSTs to the remote client nodes). In step 207, the server node comes back up (reboot is completed) and the server application is restarted, waiting for remote clients to reconnect. In this example, we hypothesize that the server reboot process took one minute. In step 208, the server node reads data from the recoverage cache to find out which sockets were active at the time of the server failure and sends RST messages for each of those sockets. In step 209, the client node receives the RST message, which causes the client application to be posted and restart the transaction (start a new socket with the server). By this example, it only took 1 minute for the client application to reconnect. In addition, if RSTs flow in the network after the server comes active again, socket state information saved in devices on the network, such as firewalls, routers, or intelligent gateways, is cleaned up allowing remote client applications to reconnect without manual intervention of the devices in the network.

With regard to the sequence of events for problem 2, described above, an implementation therein of the present invention operates as follows:

1. Client X sends a TCP connection request to server Y. A stateful firewall in front of server Y sees that no socket exists between X and Y; therefore, the firewall passes the request to the server, the socket between X and Y is established, and the firewall is aware that the socket exists. The server node writes the socket state information for this new socket to its recoverable memory cache.

2. The server node experiences a hard error and is forced to reboot. Because the server did not shut down normally, the server was unable to notify the firewall or remote client of the failure (the server was unable to send TCP RSTs to the remote client nodes). Both the firewall and remote client still think the socket exists.

3. The client sends a request message on the socket.

4. Because the server is down (still in the reboot process), no acknowledgment (ACK) to the client message is received causing the client to go through standard TCP retransmit processing. Eventually, the retransmit limit defined in the client node is reached and the client node cleans up the socket internally (no RST is sent).

5. The server node comes back up (reboot is completed) and the server application is restarted, waiting for remote clients to reconnect.

6. The server node reads data from the recoverage cache to find out which sockets were active at the time of the server failure and sends RST messages for each of those sockets.

7. The firewall sees the RST message and updates the table in the firewall to now indicate that the socket between client X and server Y no longer exists.

8. The firewall passes the RST message to the client node. The client node has already cleaned up the old socket; therefore, this RST message is discarded by the client.

9. Client X sends a TCP connection request (SYN message) to try to restart its connection with server Y (using the same IP addresses and port numbers). The firewall allows this connection request (passes it to server Y) because the firewall now knows that no socket exists between client X and server Y. A new socket is established between client X and server Y.

In this second example, the client is able to reconnect to the server as soon as the server comes back up, with no manual intervention of the firewall required.

Socket State Storage

The server writes enough socket state information to recoverable storage (optical or magnetic disk, nonvolatile cache, tape, or other storage) such that after the failure when the server comes back up, the server will be able to send out RSTs to inform remote clients of the server failure. Only a subset of the socket information need to saved. At a minimum, the following information that identifies a unique TCP connection needs to be saved in recoverable storage for each active TCP socket to enable the server to build and send a RST after a server failure. Currently, the first four items listed below uniquely identify a TCP connection.

Local IP address

Remote IP address

Local port number

Remote port number

TCP sequence number to use for the next outbound message

TCP acknowledgment (ACK) number to use for the next outbound message

IP Version (if the TCP/IP supports multiple versions, such as IPv4 and IPv6)

How and when to save the socket state information to recoverable storage is implementation dependent. The server could save the socket state information each time state information changes, which is whenever a socket is started, ended, or whenever a TCP packet is sent or received on the socket. Or the server processor could start a separate thread that will be activated on an interval basis to gather all of the socket state information for the system. Electronic circuits in the server, controllable via processor instruction include a network connected input for receiving network messages and a network connected output for sending messages, access storage for saving and retrieving socket information as needed. However implemented, the server must maintain up-to-date state information for the RST to be sent with the correct sequence and acknowledgment numbers.

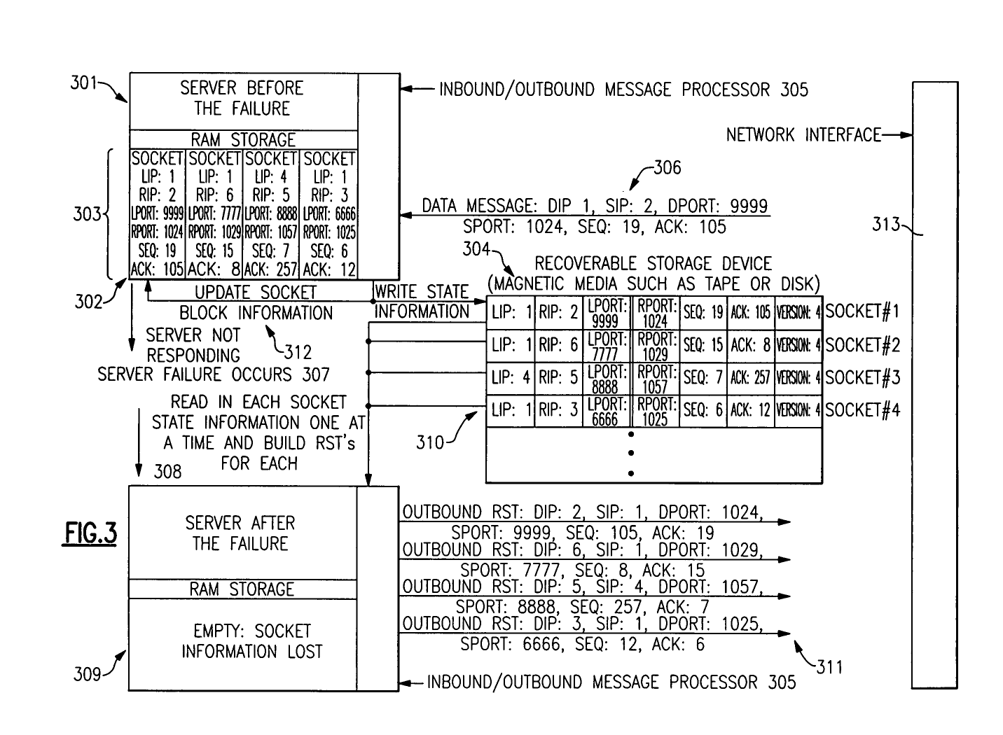

Deciding what type of hardware device to save the socket state information is also implementation dependent. Since the socket state information needs to be updated for every inbound and outbound TCP packet, determining which type of storage device to use is dependent on the workload of the system. For example, for low volume servers, an external storage device like tape drives or external disks may be sufficient to store the socket state information. With reference to FIG. 3, the sequence of events for a server 301 implementing the present invention and using an external storage device 304 is as follows:

1. 4 TCP socket connections 302 are active to this server. The socket connection information resides in Random Access Memory (RAM) storage 303 of the server.

2. Each time the server sends or receives a TCP packet to or from network 313, the Inbound/Outbound message processor 305 of the server will update the socket connection information in RAM storage 303 as well as update the state information for that socket 312 residing in the external storage device 304 (The figure shows receipt of a packet 306 for Socket #1.)

3. The server node takes a hard error and is forced to reboot 307. Because the server did not come down gracefully, the server was unable to notify the remote clients of the failure (the server was unable to send TCP RSTs to the remote client nodes).

4. The server node comes back up (reboot is completed) 308 and the server application is restarted, waiting for remote clients to reconnect. (Note: All the socket information residing in RAM storage is lost 309.)

5. The Inbound/Outbound message processor 305 will read each socket's state information 310 residing in external storage 304 and send a RST for each socket 311 based on the state information saved.

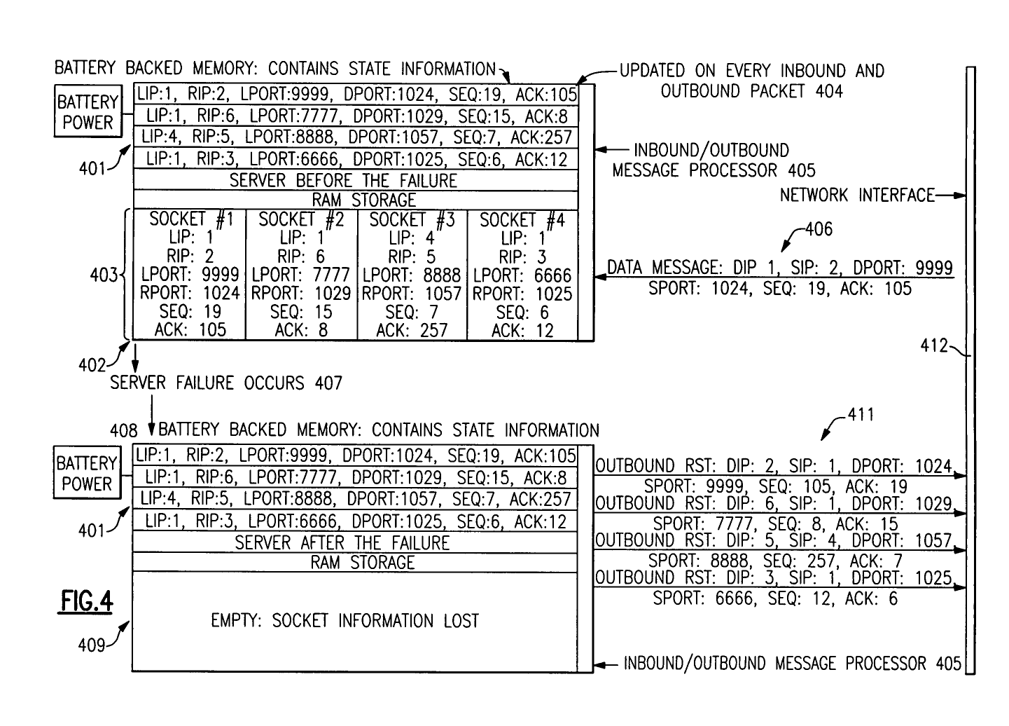

For high volume servers, a different approach may be needed to save the socket state information, rather than use the external storage devices. With regard to FIG. 4, one way this can be implemented is by using a battery backed memory device 401. These devices usually reside within the server itself and allow for much faster accessing. The sequence of events for a server implementing the present invention and using battery backed memory is as follows:

1. 4 TCP socket connections 402 are active to this server. The socket connection information resides in Random Access Memory (RAM) storage 403 of the server.

2. Each time the server sends or receives a TCP packet to or from network 412, the Inbound/Outbound message processor 405 of the server will update the socket connection information 402 in RAM storage 403 as well as update the state information for that socket residing in the battery backed memory 404 within the server (The figure shows receipt of a packet 406 for Socket #1.)

3. The server node experiences a hard error 407 and is forced to reboot. Because the server did not shut down normally, the server was unable to notify the remote clients of the failure (the server was unable to send TCP RSTs to the remote client nodes).

4. The server node comes back up (reboot is completed) 408 and the server application is restarted, waiting for remote clients to reconnect. (Note: All the socket information residing in RAM storage is lost 409, but the battery backed memory 401 contains the socket state information.)

5. The Inbound/Outbound message processor 405 will read each socket's state information residing in battery backed memory 401 and send a RST for each socket 411 based on the state information saved.

When sending RSTs after the failure, the server must account for the case where the client has quickly reconnected before the server has a chance to send an RST. For example, while the server is rebooting, the client detected that the server failed and the client cleaned up the socket on its end. As soon as the server comes back up, the client reconnects (starts a new socket). When the server reads information from the recoverable storage, before sending a RST to clean up the old socket, the server must check to see if a new socket is active with the same IP addresses and port numbers as the old socket. If so, the server does not send a RST for the old socket.

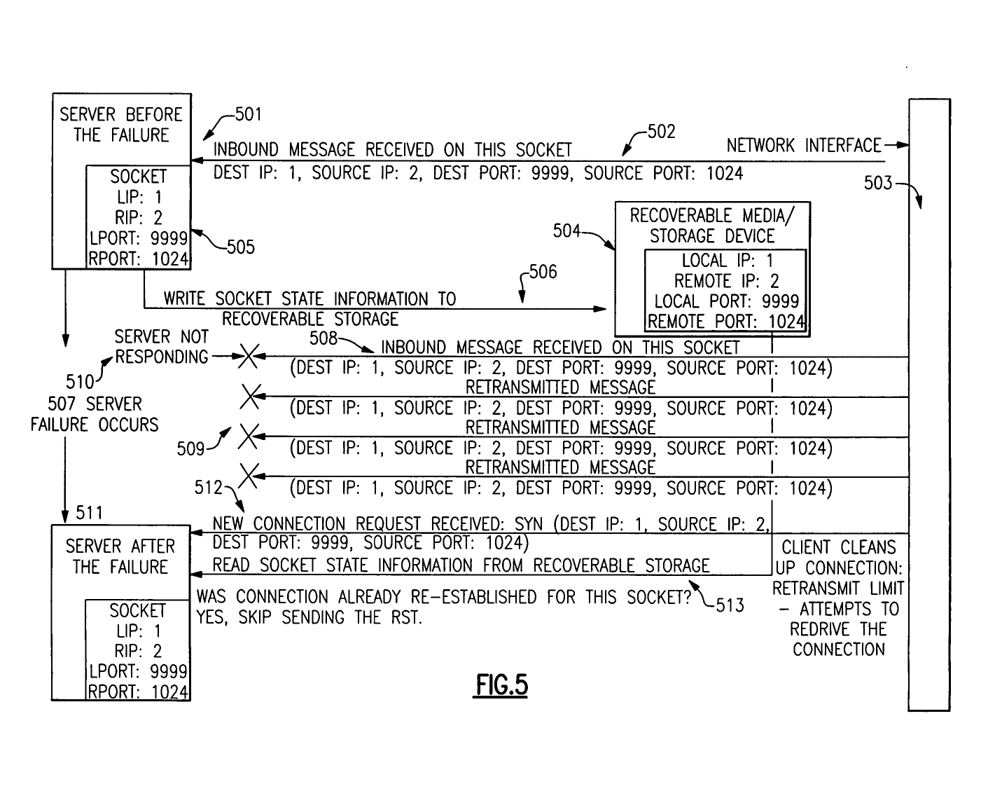

The sequence of events for this scenario is illustrated in FIG. 5:

1. An inbound message 502 is received at the server 501 from the network 503 and saved in volatile server memory 505 for the following socket:

Local IP Address: 1

Remote IP Address: 2

Local Port: 9999

Remote Port: 1024

2. The state information for this socket is saved 506 onto the recoverable storage device 504.

3. The server node takes a hard error and is forced to reboot 507. Because the server did not shut down gracefully, the server was unable to notify the firewall, router, or remote client of the failure (the server was unable to send TCP RSTs to the remote client nodes). The remote client still thinks the socket exists.

4. The client sends a request message on the socket 508.

5. Because the server is down (still in the reboot process), no acknowledgment (ACK) to the client message is sent 510 causing the client to go through standard TCP retransmit processing 509. Eventually, the retransmit limit defined in the client node is reached and the client node cleans up the socket internally (no RST is sent).

6. The server node comes back up (reboot is completed) 511 and the server application is restarted, waiting for remote clients to reconnect.

7. Before the recoverable storage 504 can be read in order to build and send RSTs, a connection request is received 512 for the same exact socket connection: (LIP: 1, RIP: 2, LPORT: 9999, RPORT: 1024). The connection request is accepted and a new socket exists with the remote client.

8. The server reads the old socket information from recoverage storage 513. When the server processes this old socket with the remote client, the server must check whether the socket has already been reestablished. When the server detects that a reestablished new socket already exists with this client, the server does not send a RST.

Another condition the server must avoid is flooding the network with RSTs which might result in some of these RST messages being lost in the network. Because a RST message is the last flow for a socket (there is no ACK to a RST), if the RST is lost in the network, it is not retransmitted and the end result is the same as if the RST were never sent. For this reason, the server should manage and control the rate at which it sends RST messages to the network.

We claim:

1. A method comprising the steps of:
receiving a data message by a network connected computing apparatus, wherein the message arrives from the network via an identified socket; and
storing socket information, carried with the message, that is capable of reestablishing the identified socket after a restart of the apparatus.

2. The method of claim 1 wherein the step of storing socket information further comprises the step of storing one or more pieces of socket information selected from the group consisting of Local IP Address, Remote IP Address, Local Port Number, Remote Port Number, TCP Sequence Number, TCP Acknowledgment Number, and IP Version.

3. The method of claim 1 wherein the step of storing socket information further comprises the step of storing socket information in one or more nonvolatile storage devices selected from the group consisting of battery backed RAM, magnetic or optical disk, tape, and nonvolatile RAM.

4. The method of claim 1 further comprising the steps of:
restarting the apparatus;
accessing the stored socket information; and
sending a reset message to the network, which includes at least some of the stored socket information, for resetting the identified socket in the network.

5. The method of claim 1 further comprising the steps of:
restarting the apparatus;
accessing the stored socket information;
checking if the identified socket has been reestablished; and
if the identified socket has not been reestablished then sending a reset message to the network, which includes at least some of the stored socket information, for resetting the identified socket in the network.

6. The method of claim 1 wherein the step of receiving a data message includes the step of receiving a plurality of data messages and wherein the step of storing socket information includes the step of storing socket information identifying sockets for the plurality of data messages, wherein the socket information is capable of reestablishing the sockets after a restart of the apparatus.

7. The method of claim 6 further comprising the steps of:
restarting the apparatus;
accessing the stored socket information; and
sending reset messages to the network at a controlled rate, which include at least some of the stored socket information, for resetting the sockets in the network.

8. A program storage device readable by a computing apparatus, tangibly embodying a program of instructions executable by the computing apparatus to perform method steps at least for storing socket information, said method steps comprising:
receiving a data message by a network connected computing apparatus, wherein the message arrives from the network via an identified socket; and
storing socket information, carried with the message, that is capable of reestablishing the identified socket after a restart of the apparatus.

9. The program storage device of claim 8 wherein the program of instructions executable by the computing apparatus to perform method steps further includes instructions wherein the step of storing socket information further comprises the step of storing one or more pieces of socket information selected from the group consisting of Local IP Address, Remote IP Address, Local Port Number, Remote Port Number, TCP Sequence Number, TCP Acknowledgment Number, and IP Version.

10. The program storage device of claim 8 wherein the program of instructions executable by the computing apparatus to perform method steps further includes instructions wherein the step of storing socket information further comprises the step of storing socket information in one or more nonvolatile storage devices selected from the group consisting of nonvolatile RAM, magnetic disk, optical disk, and tape.

11. The program storage device of claim 8 wherein the program of instructions executable by the computing apparatus to perform method steps further includes instructions for performing the steps of:
restarting the apparatus;
accessing the stored socket information; and
sending a reset message to the network, which includes at least some of the stored socket information, for resetting the identified socket in the network.

12. The program storage device of claim 8 wherein the program of instructions executable by the computing apparatus to perform method steps further includes instructions for performing the steps of:
restarting the apparatus;
accessing the stored socket information;
checking if the identified socket has been reestablished; and
if the identified socket has not been reestablished then sending a reset message to the network, which includes at least some of the stored socket information, for resetting the identified socket in the network.

13. The program storage device of claim 8 wherein the program of instructions executable by the computing apparatus to perform method steps further includes instructions wherein the step of receiving a data message includes the step of receiving a plurality of data messages and wherein the step of storing socket information includes the step of storing socket information identifying sockets for the plurality of data messages, wherein the socket information is capable of reestablishing the sockets after a restart of the apparatus.

14. The program storage device of claim 13 wherein the program of instructions executable by the computing apparatus to perform method steps further includes instructions for performing the steps of:
restarting the apparatus;
accessing the stored socket information; and
sending reset messages to the network at a controlled rate, which include at least some of the stored socket information, for resetting the sockets in the network.

15. Apparatus comprising:
an input for receiving a network data message, wherein the message arrives from the network via an identified socket; and
nonvolatile storage coupled to the input for storing socket information carried with the message that is capable of reestablishing the identified socket after a restart of the apparatus.

16. Apparatus of claim 16 further comprising:
an electronic circuit for accessing the nonvolatile storage after a restart of the apparatus; and
an output coupled to the electronic circuit for sending a reset message to the network carrying at least a portion of the socket information.

17. Apparatus of claim 16 wherein the nonvolatile storage comprises one selected from the group consisting of nonvolatile RAM, magnetic disk, optical disk, and tape.

18. Apparatus of claim 16 wherein the nonvolatile storage is external to the apparatus.

19. Apparatus of claim 16 wherein the apparatus further comprises a circuit operable after a restart of the apparatus for comparing at least some of the socket information in the nonvolatile storage with at least some socket information obtained from a socket reestablished after the restart.
